(19) United States
(12) Patent Application Publication
(10) Pub. No.: US 2026/0084451 A1
(43) Pub. Date: Mar. 26, 2026

(54) CONTROL METHOD

(71) Applicant: SEIKO EPSON CORPORATION, Tokyo (JP)

(72) Inventor: Kohei UTSUNOMIYA, MATSUMOTO-SHI (JP)

(21) Appl. No.: 19/338,551

(22) Filed: Sep. 24, 2025

(30) Foreign Application Priority Data
Sep. 26, 2024 (JP) 2024-166995

(51) Int. Cl. B41J 25/00; B41J 2/21; B41J 3/407; B41J 11/00; B41J 11/62; B41M 3/00; B41M 5/00; G06K 15/02

(52) U.S. Cl. CPC B41J 25/001; B41J 2/2103; B41J 3/4073; B41J 11/008; B41J 11/62; B41M 3/008; B41M 5/0088; G06K 15/021; G06K 15/186; G06K 2215/101

(57) ABSTRACT

There is provided a control method for controlling an operation of a three-dimensional object printing apparatus including a liquid discharge head that discharges liquid toward a workpiece, and a movement mechanism that moves the liquid discharge head, the method including a trajectory information generation step of generating trajectory information related to a movement trajectory along which the movement mechanism moves the liquid discharge head, a correspondence information generation step of generating correspondence information in which the trajectory information, head information related to the liquid discharge head, and first image information related to a first image to be printed are associated, a storage step of storing the correspondence information, and a printing data generation step of generating printing data for printing a second image based on the correspondence information and second image information related to the second image to be printed.

The present application is based on, and claims priority from JP Application Serial Number 2024-166995, filed Sep. 26, 2024, the disclosure of which is hereby incorporated by reference herein in its entirety.

### BACKGROUND

### 1. Technical Field

The present disclosure relates to a control method.

### 2. Related Art

In the related art, an apparatus that performs printing on a surface of a three-dimensional workpiece by an ink jet method is known. For example, JP-A-2024-45929 discloses an apparatus that performs printing on a workpiece by applying ink discharged from a nozzle to a workpiece by an operation of a head based on printing data while changing a position and a posture of the head by an operation of a robot based on printing path information. In JP-A-2024-45929, the printing path information is generated based on workpiece data indicating a shape of a workpiece and nozzle surface data indicating a shape of a nozzle surface.

In the apparatus described in JP-A-2024-45929, when generating printing path information, it is necessary to link the head movement trajectory with image information and nozzle surface data that are the source of the printing data. Such linking involves a high processing load. Therefore, when such linking is performed every time the image to be printed is changed, the time required for printing will increase.

### SUMMARY

According to an aspect of the present disclosure, there is provided a control method for controlling an operation of a three-dimensional object printing apparatus including a liquid discharge head that discharges liquid toward a workpiece, and a movement mechanism that moves the liquid discharge head, the control method including a trajectory information generation step of generating trajectory information related to a movement trajectory along which the movement mechanism moves the liquid discharge head, a correspondence information generation step of generating correspondence information in which the trajectory information, head information related to the liquid discharge head, and first image information related to a first image to be printed are associated, a storage step of storing the correspondence information, and a printing data generation step of generating printing data for printing a second image to be printed based on the correspondence information and second image information related to the second image.

According to an aspect of the present disclosure, there is provided a control method for controlling an operation of a three-dimensional object printing apparatus including a liquid discharge head that discharges liquid toward a workpiece, and a movement mechanism that moves the liquid discharge head, the control method including a trajectory information generation step of generating trajectory information related to a movement trajectory along which the movement mechanism moves the liquid discharge head, a first printing step of printing a first image, and a second printing step of printing a second image different from the first image, in which in both the first printing step and the second printing step, the movement mechanism moves the liquid discharge head along the movement trajectory.

### BRIEF DESCRIPTION OF THE DRAWINGS

FIG. 1 is a perspective view illustrating an outline of a three-dimensional object printing apparatus according to an embodiment.

FIG. 2 is a block diagram illustrating an electrical configuration of the three-dimensional object printing apparatus according to the embodiment.

FIG. 3 is a perspective view illustrating a schematic configuration of a head unit.

FIG. 4 is a diagram illustrating a flow of a control method according to the embodiment.

FIG. 5 is an explanatory diagram of generating a movement trajectory.

FIG. 6 is an explanatory diagram of generation of correspondence information.

FIG. 7 is an explanatory diagram of the movement trajectory and a printing region.

FIG. 8 is a diagram illustrating an example of the correspondence information.

FIG. 9 is an explanatory diagram of printing data for printing a first image.

FIG. 10 is an explanatory diagram of another example of printing data for printing the first image.

FIG. 11 is an explanatory diagram of printing data for printing a second image.

FIG. 12 is an explanatory diagram of another example of printing data for printing the second image.

FIG. 13 is an explanatory diagram of printing data for multi-color printing.

### DESCRIPTION OF EMBODIMENTS

Hereinafter, preferred embodiments according to the present disclosure will be described with reference to the accompanying drawings. In the drawings, dimensions and scale of each portion are appropriately different from actual ones, and some parts are schematically illustrated for easy understanding. In addition, the scope of the present disclosure is not limited to these forms unless it is stated in the following description that the present disclosure is particularly limited.

In the following, for convenience of description, an X-axis, a Y-axis, and a Z-axis that intersect with each other are appropriately used. In addition, hereinafter, one direction along the X-axis is an X1 direction, and a direction opposite to the X1 direction is an X2 direction. Similarly, directions opposite to each other along the Y-axis are a Y1 direction and a Y2 direction. Further, directions opposite to each other along the Z-axis are a Z1 direction and a Z2 direction.

Here, the X-axis, the Y-axis, and the Z-axis correspond to the coordinate axes of the world coordinate system set in the space where a robot 2 to be described later is installed. Typically, the Z-axis is a vertical axis, and the Z2 direction corresponds to a downward direction in a vertical direction. A base coordinate system based on the position of a base portion 210 to be described later of the robot 2 is associated with the world coordinate system by calibration. In the following, for convenience, a case where an operation of the robot 2 is controlled by using the world coordinate system as a robot coordinate system will be exemplified.

The Z-axis may not be a vertical axis. Although the X-axis, the Y-axis, and the Z-axis are typically orthogonal to each other, the present disclosure is not limited thereto, and the axes may not be orthogonal to each other. For example, the X-axis, Y-axis, and Z-axis may intersect with each other at an angle within a range of 80° or more and 100° or less.

### 1-1. Outline of Three-Dimensional Object Printing Apparatus

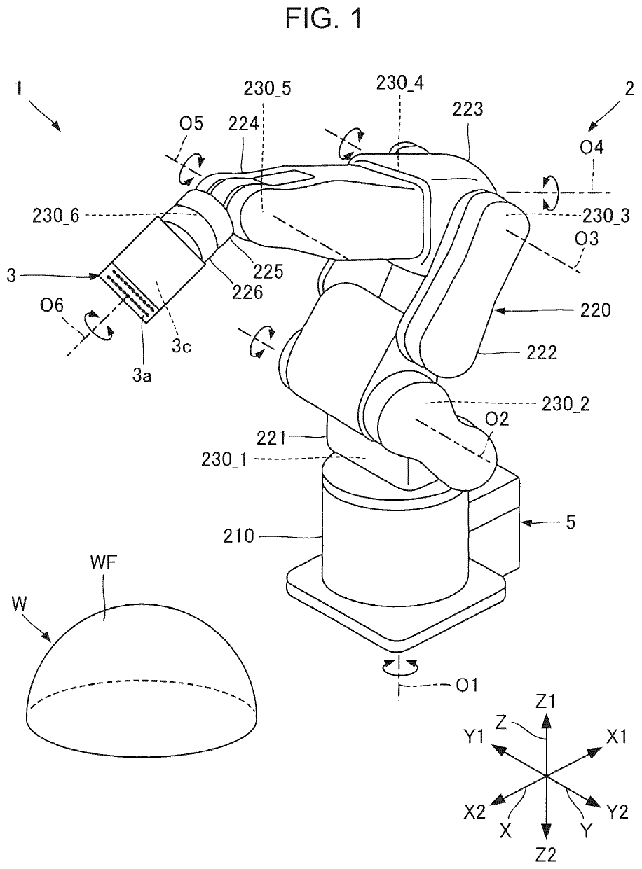

FIG. 1 is a perspective view illustrating an outline of a three-dimensional object printing apparatus 1 according to an embodiment. The three-dimensional object printing apparatus 1 is the apparatus that performs printing on a surface of a three-dimensional workpiece W by an ink jet method.

The workpiece W has a surface WF to be printed. In the example illustrated in FIG. 1, the workpiece W is a hemispherical body, and the surface WF is a projecting hemispherical surface. For example, the workpiece W during printing is supported by a structure such as a predetermined installation table, a hand of a robot other than the robot 2, which will be described below, or a conveyor, as necessary. A size, a shape, or an installation posture of the workpiece W is not limited to the example illustrated in FIG. 1, and is optional.

As illustrated in FIG. 1, the three-dimensional object printing apparatus 1 includes the robot 2, a head unit 3, and a controller 5. The robot 2 is an example of a “movement mechanism”. Hereinafter, first, the robot 2, the head unit 3, and the controller 5 will be briefly described in order.

The robot 2 is a robot that changes the position and the posture of the head unit 3 in the world coordinate system, and moves a head 3a described later. In the example illustrated in FIG. 1, the robot 2 is a so-called 6-axis vertical multi-joint robot.

As illustrated in FIG. 1, the robot 2 includes a base portion 210 and an arm portion 220.

The base portion 210 is a base that supports the arm portion 220. In the example illustrated in FIG. 1, the base portion 210 is fixed to a floor surface facing the Z1 direction or an installation surface such as a base by screwing or the like. The installation surface to which the base portion 210 is fixed may be a surface facing in any direction, is not limited to the example illustrated in FIG. 1, and may be, for example, a surface provided by a wall, a ceiling, a movable trolley, or the like.

The arm portion 220 is a 6-axis robot arm having a base end attached to the base portion 210 and a tip that changes a position and a posture three-dimensionally with respect to the base end. Specifically, the arm portion 220 includes arms 221, 222, 223, 224, 225, and 226 also referred to as links, which are coupled in this order.

The arm portion 220 includes joints 230_1 to 230_6 that couple the arms 221 to 226 to be rotatable around rotation axes O1 to O6.

Each of the joints 230_1 to 230_6 is a mechanism for rotatably coupling one of two adjacent members of the base portion 210 and the arms 221 to 226 to the other. In the following, each of the joints 230_1 to 230_6 may be referred to as a joint 230.

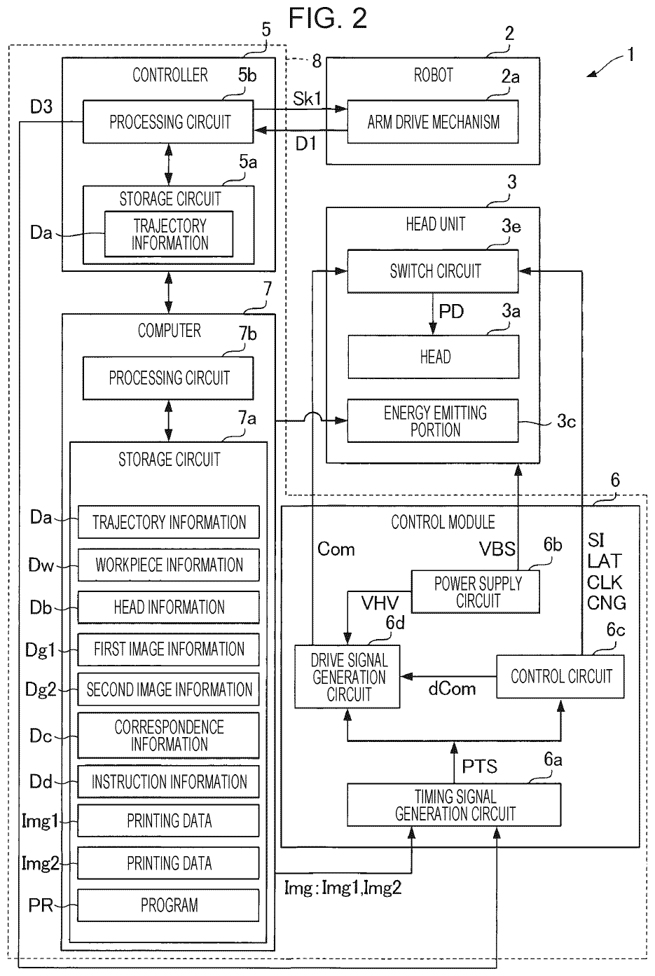

Although not illustrated in FIG. 1, each of the joints 230_1 to 230_6 is provided with a drive mechanism for rotating one of the two adjacent members corresponding to each other to the other. The drive mechanism includes, for example, a motor that generates a driving force for the rotation, a speed reducer that decelerates and outputs the driving force, an encoder such as a rotary encoder that measures the operation amount such as an angle of the rotation, and the like. An aggregation of the drive mechanisms of the joints 230_1 to 230_6 corresponds to an arm drive mechanism 2a illustrated in FIG. 2, which will be described below.

The rotation axis O1 is an axis perpendicular to the installation surface (not illustrated) to which the base portion 210 is fixed. The rotation axis O2 is an axis perpendicular to the rotation axis O1. The rotation axis O3 is an axis parallel to the rotation axis O2. The rotation axis O4 is an axis perpendicular to the rotation axis O3. The rotation axis O5 is an axis perpendicular to the rotation axis O4. The rotation axis O6 is an axis perpendicular to the rotation axis O5.

As for these rotation axes, a case where one axis is “perpendicular” to the other axis includes a case where the angle formed by the two rotation axes is strictly 90° and a case where the angle formed by the two rotation axes deviates within a range of about 90° to ±5°. Similarly, a case where one axis is “parallel” to the other axis includes a case where the two rotation axes are strictly parallel and a case where one of the two rotation axes tilts with respect to the other axis within a range of about ±5°.

The head unit 3 is mounted on the arm 226 located at the most tip among the arms 221 to 226 of the above robot 2, in a state of being fixed by screwing or the like as an end effector.

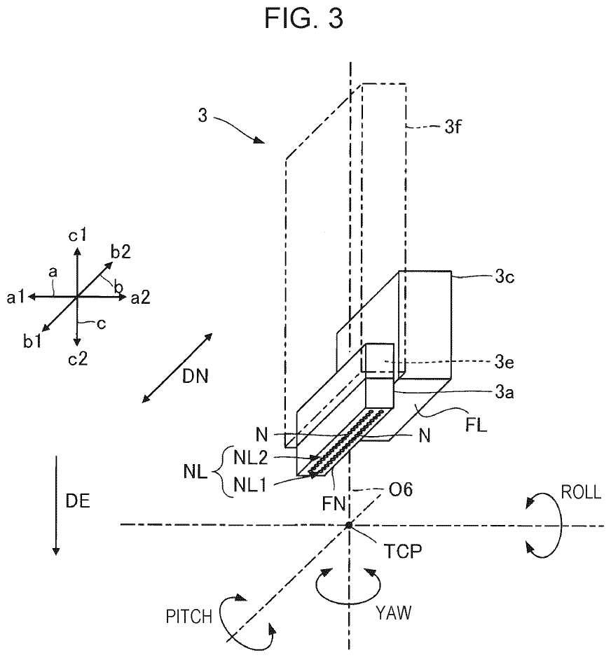

The head unit 3 is an assembly having the head 3a that discharges an ink, which is an example of a “liquid”, toward the workpiece W. The head 3a is an example of a “liquid discharge head”. In the present embodiment, the head unit 3 includes an energy emitting portion 3c in addition to the head 3a. Details of the head unit 3 will be described below with reference to FIG. 3.

The ink is not particularly limited, and examples thereof include an aqueous ink in which a coloring material such as a dye or a pigment is dissolved in an aqueous solvent, a curable ink using a curable resin such as an ultraviolet curable type resin, a solvent-based ink in which a coloring material such as a dye or a pigment is dissolved in an organic solvent, and the like.

The controller 5 is a robot controller that controls the driving of the robot 2. A computer 7 is a computer such as a desktop type or a notebook type in which a program is installed, and controls the drive of the head unit 3. Hereinafter, an electrical configuration of the three-dimensional object printing apparatus 1 will be described with reference to FIG. 2, including a detailed description of the controller 5 and computer 7.

### 1-2. Electrical Configuration of Three-Dimensional Object Printing Apparatus

FIG. 2 is a block diagram illustrating an electrical configuration of the three-dimensional object printing apparatus 1 according to the embodiment. In FIG. 2, among components of the three-dimensional object printing apparatus 1, electrical components are illustrated. As illustrated in FIG. 2, in addition to the components illustrated in FIG. 1 described above, the three-dimensional object printing apparatus 1 includes a control module 6 that is communicably connected to the controller 5 and a computer 7 that is communicably connected to the controller 5 and the control module 6. Here, a control portion 8 is configured with the controller 5, the control module 6, and the computer 7.

Each electrical component illustrated in FIG. 2 may be appropriately divided, a part thereof may be included in another component, or may be integrally formed with the other component. For example, a part or the entirety of the functions of the controller 5 or the control module 6 may be realized by the computer 7, or may be realized by another external apparatus such as a personal computer (PC) connected to the controller 5 via a network such as a local area network (LAN) or the Internet.

The controller 5 has a function of controlling the drive of the robot 2 and a function of generating a signal D3 for synchronizing an ink discharge operation of the head unit 3 with the operation of the robot 2.

The controller 5 includes a storage circuit 5a and a processing circuit 5b.

The storage circuit 5a stores various programs to be executed by the processing circuit 5b and various types of data to be processed by the processing circuit 5b. The storage circuit 5a includes, for example, one or both semiconductor memories of a volatile memory such as a random access memory (RAM) and a non-volatile memory such as a read-only memory (ROM), an electrically erasable programmable read-only memory (EEPROM) or a programmable ROM (PROM). A part or the entire of the storage circuit 5a may be included in the processing circuit 5b.

Trajectory information Da is recorded in the storage circuit 5a.

The trajectory information Da is information related to a movement trajectory RU in which the robot 2 moves the head 3a, and includes information indicating the position and the posture of the head 3a in the path along which the head 3a is to be moved when a printing operation is executed. The trajectory information Da is represented by using, for example, coordinate values of a workpiece coordinate system based on the position of the workpiece W, the base coordinate system, or the world coordinate system. The trajectory information Da is generated by a processing circuit 7b, and is input from the processing circuit 7b to the storage circuit 5a. When the trajectory information Da is represented by using a coordinate value of the workpiece coordinate system, the trajectory information Da is used for controlling the operation of the robot 2 after conversion from the coordinate value of the workpiece coordinate system to a coordinate value of the base coordinate system or the world coordinate system.

The processing circuit 5b controls an operation of the arm drive mechanism 2a of the robot 2 based on the trajectory information Da, and generates the signal D3. The processing circuit 5b includes, for example, one or more processors such as a central processing unit (CPU). The processing circuit 5b may include a programmable logic device such as a field-programmable gate array (FPGA) instead of the CPU or in addition to CPU.

Here, the arm drive mechanism 2a is an aggregation of the drive mechanisms of the joints 230_1 to 230_6 described above, and includes a motor for driving the joint of the robot 2 and an encoder that measures a rotation angle of the joint of the robot 2, for each joint 230.

The processing circuit 5b performs an inverse kinematics calculation, which is an arithmetic operation for converting the trajectory information Da into the operation amount such as a rotation angle and a rotation speed of each joint 230 of the robot 2. The processing circuit 5b outputs a control signal Sk1 based on an output D1 from each encoder of the arm drive mechanism 2a so that the operation amount such as the actual rotation angle and the rotation speed of each joint 230 becomes the arithmetic operation result described above based on the trajectory information Da. The control signal Sk1 is a signal for controlling the drive of the motor of the arm drive mechanism 2a. Here, the control signal Sk1 is corrected by the processing circuit 5b based on the output from the acceleration sensor or the distance sensor (not illustrated) as necessary.

In addition, the processing circuit 5b generates the signal D3, based on the output D1 from at least one of a plurality of encoders included in the arm drive mechanism 2a. For example, the processing circuit 5b generates a trigger signal including a pulse at a timing at which the output D1 from one of the plurality of encoders becomes a predetermined value as the signal D3.

The control module 6 is a circuit that controls an ink discharge operation in the head unit 3 based on the signal D3 output from the controller 5 and printing data Img from the computer 7. The control module 6 includes a timing signal generation circuit 6a, a power supply circuit 6b, a control circuit 6c, and a drive signal generation circuit 6d.

The timing signal generation circuit 6a generates a timing signal PTS based on the signal D3. The timing signal generation circuit 6a is configured with, for example, a timer that starts generation of the timing signal PTS by using detection of the signal D3 as a trigger.

The power supply circuit 6b receives power supply from a commercial power supply (not illustrated) to generate various predetermined potentials. The various generated potentials are appropriately supplied to each portion of the control module 6 and the head unit 3. For example, the power supply circuit 6b generates a power supply potential VHV and an offset potential VBS. The offset potential VBS is supplied to the head unit 3. In addition, the power supply potential VHV is supplied to the drive signal generation circuit 6d.

The control circuit 6c generates a control signal SI, a waveform designation signal dCom, a latch signal LAT, a clock signal CLK, and a change signal CNG, based on the timing signal PTS. These signals are synchronized with the timing signal PTS. Among these signals, the waveform designation signal dCom is input to the drive signal generation circuit 6d, and the other signals are input to a switch circuit 3e of the head unit 3.

The control signal SI is a digital signal for designating an operation state of a drive element included in the head 3a of the head unit 3. Specifically, the control signal SI is a signal for designating whether or not to supply a drive signal Com to be described later to the drive element based on the printing data Img. With this designation, for example, whether or not to discharge inks from a nozzle corresponding to the drive element is designated, and the amount of ink discharged from the nozzle is designated. The waveform designation signal dCom is a digital signal for defining a waveform of the drive signal Com. The latch signal LAT and the change signal CNG are signals for defining a discharge timing of the ink from the nozzle, in combination with the control signal SI, by defining a drive timing of the drive element. The clock signal CLK is a reference clock signal synchronized with the timing signal PTS.

The above control circuit 6c includes, for example, one or more processors such as a CPU. The control circuit 6c may include a programmable logic device such as an FPGA instead of the CPU or in addition to the CPU.

The drive signal generation circuit 6d is a circuit that generates the drive signal Com for driving each drive element included in the head 3a of the head unit 3. Specifically, the drive signal generation circuit 6d includes, for example, a DA conversion circuit and an amplifier circuit. In the drive signal generation circuit 6d, the DA conversion circuit converts the waveform designation signal dCom from the control circuit 6c from a digital signal to an analog signal, and the amplifier circuit uses the power supply potential VHV from the power supply circuit 6b to amplify the analog signal and generate the drive signal Com. Here, among waveforms included in the drive signal Com, a signal of a waveform actually supplied to the drive element is a drive pulse PD. The drive pulse PD is supplied from the drive signal generation circuit 6d to the drive element, via the switch circuit 3e of the head unit 3.

Here, the switch circuit 3e is a circuit including a switching element that switches whether or not to supply at least a part of the waveform included in the drive signal Com as the drive pulse PD based on the control signal SI.

The computer 7 has a function of generating the trajectory information Da, a function of supplying information such as the trajectory information Da to the controller 5, and a function of supplying information such as the printing data Img to the control module 6. In addition to these functions, the computer 7 of the present embodiment has a function of controlling a drive of the energy emitting portion 3c.

The computer 7 includes a storage circuit 7a and the processing circuit 7b. The storage circuit 7a is an example of a “storage portion”. In addition, although not illustrated, the computer 7 has an input device that accepts an operation from a user, such as a keyboard or a mouse. The computer 7 may have a display device that displays information necessary for generating the trajectory information Da, such as a liquid crystal panel.

The storage circuit 7a stores various programs to be executed by the processing circuit 7b and various types of data to be processed by the processing circuit 7b. The storage circuit 7a includes, for example, one or both semiconductor memories of a volatile memory such as a RAM and a non-volatile memory such as a ROM, an EEPROM, or a PROM. A part or the entire of the storage circuit 7a may be included in the processing circuit 7b.

The storage circuit 7a stores the trajectory information Da, workpiece information Dw, head information Db, first image information Dg1, second image information Dg2, correspondence information Dc, instruction information Dd, printing data Img1 and Img2, and a program PR.

The workpiece information Dw is data representing a shape of at least a part of the workpiece W. Specifically, the workpiece information Dw is three-dimensional data such as a standard triangulated language (STL) format representing the shape of the workpiece W by a plurality of polygons. The workpiece information Dw is obtained by, for example, performing conversion processing on computer-aided design (CAD) data indicating a three-dimensional shape of the workpiece W as necessary, or by measuring the shape of the workpiece W by a known three-dimensional shape measurement method. The workpiece information Dw may be represented by using coordinate values of the workpiece coordinate system, or may be represented by point group data using coordinate values of the base coordinate system or the world coordinate system. Further, the workpiece information Dw may be represented by an equation or the like, and a format of the workpiece information Dw can be appropriately converted as needed.

The head information Db is information related to the head 3a. Specifically, the head information Db is information for representing a plurality of nozzles N of the head 3a as a virtual object in a virtual space VS, and includes, for example, information indicating the model of the head 3a, the number of nozzles N, the nozzle number for specifying the nozzle N, the position of each nozzle N, the ink color, the position of a tool center point TCP described later, and the like.

The first image information Dg1 is information related to a first image G1 to be printed, which will be described later. More specifically, the first image information Dg1 is information indicating the first image G1 in a two-dimensional manner, and is, for example, image data created by image editing software. The data format of the first image information Dg1 is not particularly limited, and is, for example, a format in a page description language such as PostScript, Portable Document Format (PDF), and XML Paper Specification (XPS), or image data in various vector formats or raster formats.

The second image information Dg2 is information related to a second image G2 to be printed, which will be described later. More specifically, the second image information Dg2 is information indicating the second image G2 different from the first image G1 in a two-dimensional manner, and is, for example, image data created by image editing software. The data format of the second image information Dg2 is not particularly limited, and is, for example, a format in a page description language such as PostScript, Portable Document Format (PDF), and XML Paper Specification (XPS), or image data in various vector formats or raster formats.

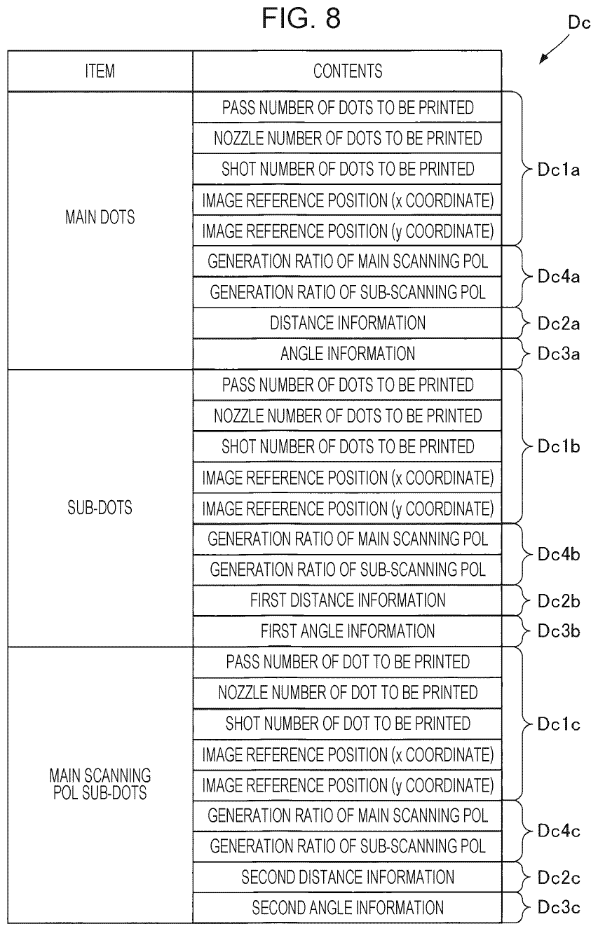

The correspondence information Dc is information in which the trajectory information Da, the head information Db, and the first image information Dg1 are associated with each other. Specifically, the correspondence information Dc is information indicating which nozzle N in which shot of which pass should be used to apply color information corresponding to which pixel of the first image G1 indicated by the first image information Dg1. The details of the correspondence information Dc will be described later with reference to FIG. 8.

The instruction information Dd is information related to a user's instruction. The instruction is, for example, a setting instruction related to the size of an overlapping region such as a first overlapping region OV1a described later, and is used for adjusting the overlapping region.

The printing data Img1 is printing data Img for printing the first image G1 on the workpiece W, and indicates an image obtained by dividing the first image G1 for each printing trajectory (pass) of the movement trajectory indicated by the trajectory information Da.

The printing data Img2 is printing data Img for printing the second image G2 on the workpiece W, and indicates an image obtained by dividing the second image G2 for each printing trajectory (pass) of the movement trajectory indicated by the trajectory information Da.

The program PR is a program for executing a control method described later.

The processing circuit 7b realizes each of the functions described above by executing a program such as the program PR. The processing circuit 7b includes, for example, one or more processors such as a CPU. The processing circuit 7b may include a programmable logic device such as an FPGA instead of the CPU or in addition to the CPU.

The processing circuit 7b realizes various functions for the control method described later by executing the program PR. Specifically, as will be described in detail later, the processing circuit 7b generates the printing data Img1 when printing the first image G1 indicated by the first image information Dg1. At this time, the processing circuit 7b generates the printing data Img1 based on the workpiece information Dw, the first image information Dg1, and the head information Db, and in the generation process, generates the trajectory information Da or the correspondence information Dc. Further, the processing circuit 7b generates the printing data Img2 when printing the second image G2 indicated by the second image information Dg2. At this time, when the printing trajectory indicated by the trajectory information Da is available at the time of printing the second image G2, for example, when the shape of the workpiece W is the same as that at the time of printing the first image G1, the processing circuit 7b generates the printing data Img2 based on the correspondence information Dc and the second image information Dg2 without newly generating the trajectory information Da.

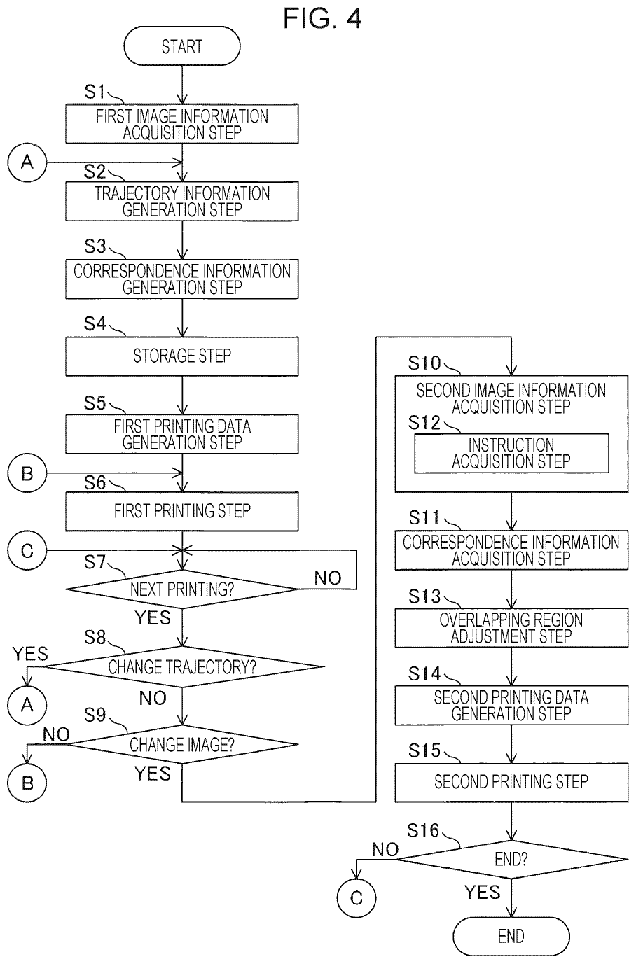

As described above, the correspondence information Dc generated as intermediate data when the printing data Img1 of the first image G1 is generated is used for generating the printing data Img2 of the second image G2. Therefore, it is not necessary to create the movement trajectory RU for each image, and as a result, the time required to create the movement trajectory RU can be reduced. The details of the control method will be described later with reference to FIGS. 4 to 13.

As described above, by controlling the drive of the robot 2 based on the trajectory information Da and controlling the drive of the head 3a based on the printing data Img and the signal D3, a printing operation is performed. In the printing operation, while the robot 2 changes the position and the posture of the head 3a based on the trajectory information Da, the head 3a discharges inks from the head 3a toward the workpiece W at an appropriate timing based on the printing data Img and the signal D3. Thus, an image based on the printing data Img is formed at the workpiece W.

### 1-3. Configuration of Head Unit

FIG. 3 is a perspective view illustrating a schematic configuration of the head unit 3. In the following description, for convenience, an a-axis, a b-axis, and a c-axis that intersect with each other will be appropriately used. In addition, in the following description, one direction along the a-axis is an a1 direction, and a direction opposite to the a1 direction is an a2 direction. Similarly, directions opposite to each other along the b-axis are a b1 direction and a b2 direction. In addition, directions opposite to each other along the c-axis are a c1 direction and a c2 direction.

Here, the a-axis, the b-axis, and the c-axis correspond to coordinate axes of a tool coordinate system set in the head unit 3, and relative positions and relationships of postures with the world coordinate system or the robot coordinate system described above are changed by the operation of the robot 2 described above. In the example illustrated in FIG. 3, the c-axis is an axis parallel to the rotation axis O6 described above. The a-axis, the b-axis, and the c-axis are typically orthogonal to each other.

In the following, the a-axis may be referred to as a “roll axis”, the b-axis may be referred to as a “pitch axis”, and the c-axis may be referred to as a “yaw axis”. In addition, a rotation around the a-axis may be referred to as “roll”, a rotation around the b-axis may be referred to as “pitch”, and a rotation around the c-axis may be referred to as “yaw”.

The tool coordinate system is set with reference to the tool center point TCP. Therefore, the position and the posture of the head 3a are defined with reference to the tool center point TCP. In the present embodiment, in the example illustrated in FIG. 3, the tool center point TCP is disposed in a space separated by a predetermined spacing in a discharge direction DE of the ink from a center of a nozzle array NL of the head 3a in the b-axis direction. The position of the tool center point TCP is not limited to the example illustrated in FIG. 3, and may be, for example, a center of a nozzle surface FN.

As described above, the head unit 3 includes the head 3a and the energy emitting portion 3c. The head 3a and the energy emitting portion 3c are supported by a support body 3f illustrated by a two-dot chain line in FIG. 3. In the example illustrated in FIG. 3, the number of the heads 3a included in the head unit 3 is one, but the number is not limited to the example illustrated in FIG. 3, and may be two or more. In addition, the energy emitting portion 3c may be provided as necessary or may be omitted.

The support body 3f is made of, for example, a metal material or the like, and is a substantially rigid body. In FIG. 3, the support body 3f has a planar box shape, and the shape of the support body 3f is not particularly limited, and is optional.

The above support body 3f is mounted to the arm 226 described above. Therefore, the head 3a and the energy emitting portion 3c are collectively supported by the arm 226 by the support body 3f. Therefore, the relative positions of the head 3a and the energy emitting portion 3c with respect to the arm 226 are fixed.

The head 3a is a liquid discharge head, and includes the nozzle surface FN and the plurality of nozzles N that are open to the nozzle surface FN. The nozzle surface FN is a nozzle surface on which the nozzle N is opened. In the example illustrated in FIG. 3, a normal direction of the nozzle surface FN, that is, the discharge direction DE of the ink from the nozzle N is the c2 direction.

The plurality of nozzles N are divided into a first nozzle array NL1 and a second nozzle array NL2, which are arranged with spacing from each other in a direction along the a-axis. Each of the first nozzle array NL1 and the second nozzle array NL2 is a set of the plurality of nozzles N linearly arrayed in a nozzle array direction DN which is a direction along the b-axis.

In the following, the entire first nozzle array NL1 and the entire second nozzle array NL2 may be referred to as a nozzle array NL. The nozzle array NL includes the first nozzle array NL1 and the second nozzle array NL2.

Although not illustrated, the head 3a includes a piezoelectric element which is a drive element and a cavity for accommodating inks, for each nozzle N. Here, ink is supplied to the head 3a from an ink tank (not illustrated). The piezoelectric element discharges an ink in the discharge direction DE from the nozzle N corresponding to the cavity, by changing a pressure of the cavity corresponding to the piezoelectric element. As a drive element for discharging the ink from the nozzle N, a heater that heats the ink in the cavity may be used, instead of a piezoelectric element.

The energy emitting portion 3c emits energy such as light, heat, an electron beam, or radiation for curing or solidifying the ink on the workpiece W. For example, when the ink has ultraviolet curability, the energy emitting portion 3c is configured with a light emitting element such as a light emitting diode (LED) that emits ultraviolet rays.

### 1-4. Control Method

FIG. 4 is a diagram illustrating a flow of a control method according to the embodiment. The control method is a method of controlling the operation of the three-dimensional object printing apparatus 1, and is realized by the processing circuit 7b executing the program PR described above. As illustrated in FIG. 4, the control method includes a first image information acquisition step S1, a trajectory information generation step S2, a correspondence information generation step S3, a storage step S4, a first printing data generation step S5, a first printing step S6, determination steps S7, S8, and S9, a second image information acquisition step S10, a correspondence information acquisition step S11, an instruction acquisition step S12, an overlapping region adjustment step S13, a second printing data generation step S14, a second printing step S15, and a determination step S16. The second printing data generation step S14 is an example of the “printing data generation step”.

In the control method, first, in the first image information acquisition step S1, the processing circuit 7b acquires the first image information Dg1. This acquisition is performed, for example, by the processing circuit 7b reading the first image information Dg1 from the storage circuit 7a or the like. In the first image information acquisition step S1, in addition to the acquisition of the first image information Dg1, the head information Db, the workpiece information Dw, and the setting value are acquired. The acquisition of the head information Db and the workpiece information Dw is performed, for example, by the processing circuit 7b reading the head information Db and the workpiece information Dw from the storage circuit 7a or the like. The setting value includes, for example, a setting value of a distance PG between the head 3a and the workpiece W, a setting value of a mask pattern, and the like. The setting value is acquired, for example, in response to an input by the user's operation. The setting value may be automatically set by the processing circuit 7b according to the distance PG between the known head 3a and the workpiece W, or may be set by the user's input. In addition, the setting value includes an allowable range of designation by the user for the difference between the distance PG corresponding to a main dot described later and the distance PG of each sub-dot. In addition, the setting value may include information related to the type of the first image G1, for example, information related to a line drawing, a photograph, or the like.

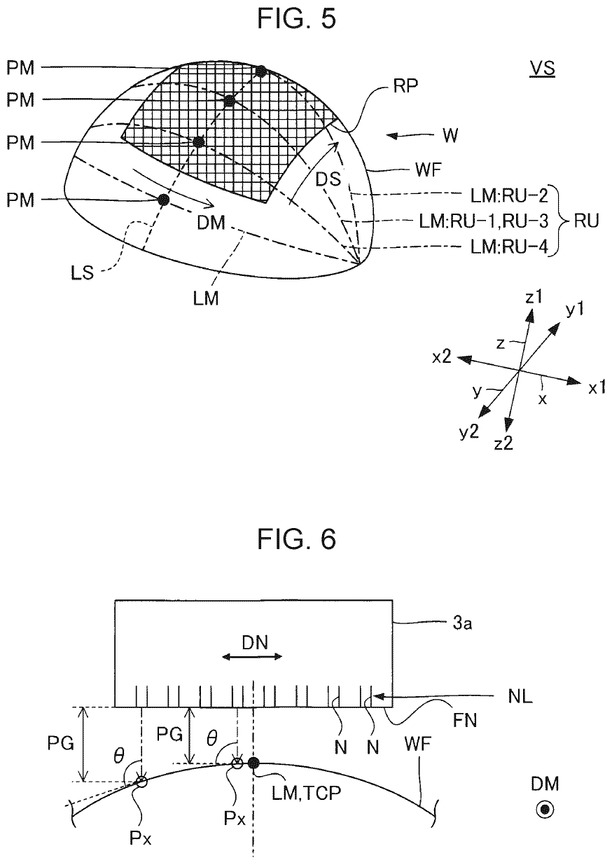

After the first image information acquisition step S1, in the trajectory information generation step S2, the processing circuit 7b generates the trajectory information Da based on the first image information Dg1, the head information Db, the workpiece information Dw, and the setting value acquired in the first image information acquisition step S1. The generated trajectory information Da is stored in the storage circuit 7a. Details of the trajectory information generation step S2 will be described later with reference to FIG. 5.

After the trajectory information generation step S2, in the correspondence information generation step S3, the processing circuit 7b generates the correspondence information Dc based on the trajectory information Da, the first image information Dg1, the head information Db, and the workpiece information Dw. Details of the correspondence information generation step S3 will be described later with reference to FIGS. 6 to 8.

After the correspondence information generation step S3, in the storage step S4, the processing circuit 7b stores the correspondence information Dc in the storage circuit 7a.

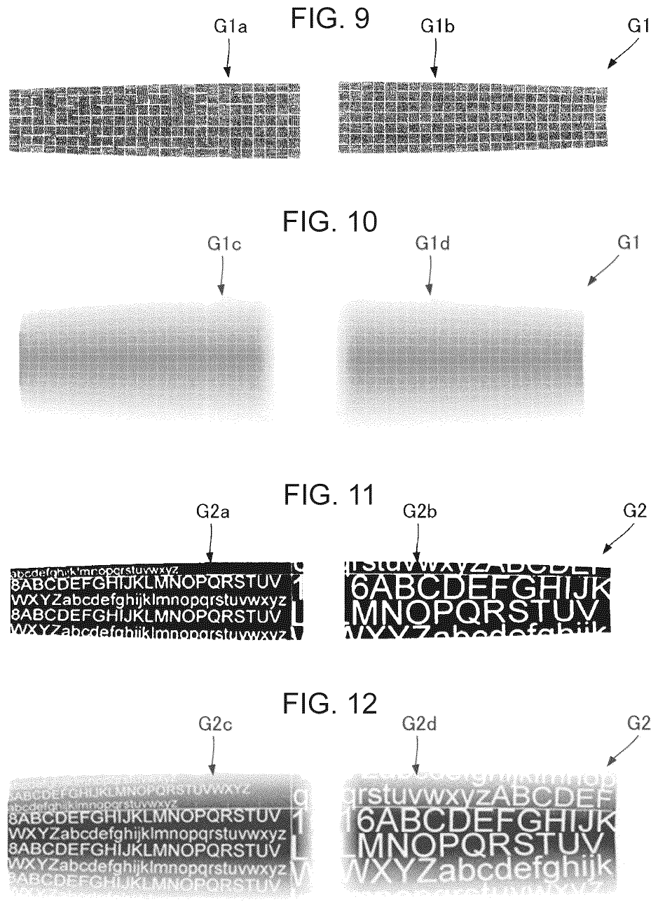

After the storage step S4, in the first printing data generation step S5, the processing circuit 7b generates the printing data Img1 based on the correspondence information Dc and the first image information Dg1. The generated printing data Img1 is stored in the storage circuit 7a. Details of the first printing data generation step S5 will be described later with reference to FIGS. 9 and 10. The first printing data generation step S5 may be performed after the correspondence information generation step S3 and before the storage step S4, or may be performed in parallel with the storage step S4.

After the first printing data generation step S5, in the first printing step S6, the processing circuit 7b prints the first image G1 indicated by the first image information Dg1 on the workpiece W. Details of the first printing step S6 will be described later with reference to FIGS. 9 and 10.

After the first printing step S6, in the determination step S7, the processing circuit 7b determines whether to perform the next printing on the new workpiece W. This determination is made, for example, based on the presence or absence of the next printing instruction by the user's operation. The determination step S7 is repeatedly executed until the next printing is determined to be performed (determination step S7: NO). Therefore, for example, the three-dimensional object printing apparatus 1 is in a state of waiting for printing until the next printing instruction is performed by the user's operation. It is preferable that this state is maintained even if the power of the three-dimensional object printing apparatus 1 is turned off.

When the next printing is performed (determination step S7: YES), in determination step S8, the processing circuit 7b determines whether to change the movement trajectory RU. This determination is made based on, for example, whether or not the shape of the workpiece W is changed, whether or not there is a change instruction by the operation of the user, and the like. Typically, in the determination step S8, when the shape of the workpiece W is changed, the processing circuit 7b determines to change the movement trajectory RU. On the other hand, in the determination step S8, when the shape of the workpiece W is not changed, the processing circuit 7b determines not to change the movement trajectory RU.

When the movement trajectory RU is changed (YES in the determination step S8), the processing circuit 7b returns to the trajectory information generation step S2. Therefore, the processing from the above-described trajectory information generation step S2 to the determination step S7 is executed again. However, in the trajectory information generation step S2 again, the trajectory information Da is generated based on third image information, the head information Db, the workpiece information Dw, and the setting value by using the third image information indicating the third image instead of the first image information Dg1 after the workpiece information Dw is changed to the information related to the workpiece W whose shape is changed. The third image may be the same as or different from the first image G1. In addition, the setting value used for generating the trajectory information Da may be changed as necessary.

When the movement trajectory RU is not changed (determination step S8: NO), in the determination step S9, the processing circuit 7b determines whether to change the image to be printed from the first image G1 to the second image G2. This determination is made based on, for example, the presence or absence of an instruction to change the setting by the user's operation.

When the image is not changed (determination step S9: NO), the processing circuit 7b returns to the first printing step S6. Therefore, the first image G1 is printed again.

When the image is changed (determination step S9: YES), the processing circuit 7b acquires the second image information Dg2 in the second image information acquisition step S10. This acquisition is performed, for example, by the processing circuit 7b reading the second image information Dg2 from the storage circuit 7a or the like. In the second image information acquisition step S10, in addition to the acquisition of the second image information Dg2, the setting value is acquired. The setting value includes, for example, a setting value of the distance PG between the head 3a and the workpiece W, a setting value of an overlapping region such as the first overlapping region OV1a described later, a setting value of a mask pattern, and the like. The setting value is acquired, for example, in response to an input by the user's operation. Here, the second image information acquisition step S10 includes an instruction acquisition step S12 related to the user's instruction. In the instruction acquisition step S12, the setting value is acquired. The setting value may be acquired in response to the input by the user's operation, or may be automatically acquired based on the execution of a predetermined program or the like. In addition, the setting value includes an allowable range of designation by the user for the difference between the distance PG corresponding to a main dot described later and the distance PG of each sub-dot. The setting value may include information related to the type of the second image G2, for example, information related to a line drawing, a photograph, or the like.

After the second image information acquisition step S10, in the correspondence information acquisition step S11, the processing circuit 7b acquires the correspondence information Dc. This acquisition is performed by the processing circuit 7b reading the correspondence information Dc from the storage circuit 7a. The correspondence information acquisition step S11 may be executed before the second image information acquisition step S10, or may be executed in parallel with the second image information acquisition step S10.

After the correspondence information acquisition step S11, in the overlapping region adjustment step S13, the processing circuit 7b adjusts the size of the overlapping region such as the first overlapping region OV1a described later. This adjustment is performed, for example, based on the instruction information Dd so that the distance PG between the nozzle N of the head 3a and the workpiece W is as small as possible, and an angle θ formed by the discharge direction DE of the liquid from the nozzles N of the head 3a and the workpiece W is as close as possible to 90°.

After the overlapping region adjustment step S13, in the second printing data generation step S14, the processing circuit 7b generates the printing data Img2 based on the correspondence information Dc and the second image information Dg2. The generated printing data Img2 is stored in the storage circuit 7a. Details of the second printing data generation step S14 will be described later with reference to FIGS. 11 to 13. The overlapping region adjustment step S13 may be included in the second printing data generation step S14.

After the second printing data generation step S14, in the second printing step S15, the processing circuit 7b prints the second image G2 indicated by the second image information Dg2 on the workpiece W. Details of the second printing step S15 will be described later with reference to FIGS. 11 to 13.

After the second printing step S15, in the determination step S16, the processing circuit 7b determines whether to end the process. This determination is made based on, for example, the presence or absence of an end instruction by the user's operation.

When the process is not ended (determination step S16: NO), the processing circuit 7b returns to the determination step S7. As a result, the three-dimensional object printing apparatus 1 is in a state of waiting for printing until the next printing instruction is performed by the user's operation. On the other hand, when the process is ended (determination step S16: YES), the processing circuit 7b ends the process.

### 1-5. Generation of Movement Trajectory

FIG. 5 is an explanatory diagram of the generation of the movement trajectory RU. In FIG. 5, the workpiece W in the virtual space VS is illustrated. In the virtual space VS, a coordinate system is set with mutually intersecting x-axis, y-axis, and z-axis as coordinate axes. Here, the x-axis corresponds to the X-axis, one direction along the x-axis is an x1 direction, and a direction opposite to the x1 direction is an x2 direction. The y-axis corresponds to the Y-axis, and directions opposite to each other along the y-axis are a y1 direction and a y2 direction. The z-axis corresponds to the Z-axis, and directions opposite to each other along the z-axis are a z1 direction and a z2 direction. Although the x-axis, the y-axis, and the z-axis are typically orthogonal to each other, the configuration is not limited thereto, and all of these may intersect with each other at an angle within a range equal to or more than 80° and equal to or less than 100°.

In the trajectory information generation step S2, first, as illustrated in FIG. 5, the workpiece W is disposed in the virtual space VS based on the workpiece information Dw, and a printing region RP is set based on the first image information Dg1. Then, a plurality of reference paths LM are set. As a method of setting the plurality of reference paths LM, the contents (method of setting a plurality of candidate paths) of U.S. Patent Application Publication No. 2024/0269855, which was published on Aug. 15, 2024, are incorporated herein as a reference.

The plurality of reference paths LM are arranged with spacing in a sub-scanning direction DS, which intersects a main scanning direction DM. The main scanning direction DM is a direction along any one of the plurality of reference paths LM. Here, in the virtual space VS, a plurality of reference points PM are set on the workpiece W on a sub-scanning reference line LS along the sub-scanning direction DS, and the plurality of reference paths LM are set for each reference point PM. Each of the plurality of reference paths LM passes through the corresponding reference point PM, and intersects with the sub-scanning reference line LS.

In the trajectory information generation step S2, after the plurality of reference paths LM are set as described above, the movement trajectory RU suitable for the execution of the printing operation on the printing region RP is generated by using at least one reference path LM among the plurality of reference paths LM. In the present embodiment, after three reference paths LM are selected from the plurality of reference paths LM, the movement trajectory RU including a first printing trajectory RU-1, a second printing trajectory RU-2, a third printing trajectory RU-3, and a fourth printing trajectory RU-4 is generated by using the three reference paths LM.

More specifically, in the trajectory information generation step S2 of the present embodiment, among the plurality of reference paths LM, three reference paths LM are selected as a combination of the minimum number of reference paths LM that can satisfy the entire printing region RP. Then, for the central reference path LM among the three reference paths LM, the reference path LM is divided into two paths having an appropriate length, and then a path for the run-up of the head 3a and a path for the pre-curing of the ink by the energy emitting portion 3c are added to both ends of each of the divided paths, thereby generating the first printing trajectory RU-1 and the third printing trajectory RU-3. In addition, for the reference path LM adjacent to one of the three reference paths LM with respect to the central reference path LM, a path for the run-up of the head 3a and a path for pre-curing of the ink by the energy emitting portion 3c are added to both ends of the reference path LM, thereby generating the second printing trajectory RU-2. Furthermore, for the reference path LM adjacent to the other of the three reference paths LM with respect to the central reference path LM, a path for the run-up of the head 3a and a path for pre-curing of the ink by the energy emitting portion 3c are added to both ends of the reference path LM, thereby generating the fourth printing trajectory RU-4.

One or both of the second printing trajectory RU-2 and the fourth printing trajectory RU-4 may be printing trajectories divided in the main scanning direction DM, similar to the first printing trajectory RU-1 and the third printing trajectory RU-3, by dividing the reference path LM into two paths having an appropriate length, and then adding a path for the run-up of the head 3a and a path for pre-curing of the ink by the energy emitting portion 3c to both ends of each of the divided paths. In addition, the first printing trajectory RU-1 and the third printing trajectory RU-3 may be printing trajectories that are not divided in the main scanning direction DM, similar to the second printing trajectory RU-2 or the fourth printing trajectory RU-4. Furthermore, at least one of the second printing trajectory RU-2, the third printing trajectory RU-3, and the fourth printing trajectory RU-4 may be generated as necessary and may be omitted. In addition to the first printing trajectory RU-1, the second printing trajectory RU-2, the third printing trajectory RU-3, and the fourth printing trajectory RU-4, other printing trajectories may be generated.

In addition, when generating the first printing trajectory RU-1, the second printing trajectory RU-2, the third printing trajectory RU-3, and the fourth printing trajectory RU-4, the presence or absence of a collision between the head 3a and the workpiece W on each trajectory is determined by simulation based on the setting value of the distance PG between the head 3a and the workpiece W and the information indicated by the head information Db, and each trajectory is appropriately corrected based on the determination result.

The contents of the U.S. Patent Application Publication No. 2024/0269855 published on Aug. 15, 2024 (method of setting a plurality of candidate paths) are incorporated herein as a reference as a method of generating each of the first printing trajectory RU-1, the second printing trajectory RU-2, the third printing trajectory RU-3, and the fourth printing trajectory RU-4.

### 1-6. Generation of Correspondence Information

FIG. 6 is an explanatory diagram of generation of the correspondence information Dc. The first image G1 indicated by the first image information Dg1 is divided for each printing trajectory (pass) of the first printing trajectory RU-1, the second printing trajectory RU-2, the third printing trajectory RU-3, and the fourth printing trajectory RU-4 described above, and is printed on the workpiece W. Therefore, in order to generate the printing data Img1, it is necessary to specify the correspondence relationship between each nozzle N of the head 3a in the movement trajectory RU and a pixel Px of the first image G1 indicated by the first image information Dg1 for each printing trajectory of the first printing trajectory RU-1, the second printing trajectory RU-2, the third printing trajectory RU-3, and the fourth printing trajectory RU-4 as illustrated in FIG. 6. In the correspondence information generation step S3, the correspondence information Dc related to the correspondence relationship is generated as intermediate data.

More specifically, in the correspondence information generation step S3, after the first image G1 indicated by the first image information Dg1 is pasted in the printing region RP, for each of the printing trajectories of the first printing trajectory RU-1, the second printing trajectory RU-2, the third printing trajectory RU-3, and the fourth printing trajectory RU-4, an intersection between the printing region RP and a virtual line extending in the discharge direction DE from each of the nozzles N of the head 3a indicated by the head information Db is obtained, and the pixel Px corresponding to the intersection is specified.

In the correspondence information generation step S3, when printing the first image G1 so that the regions printed on the workpiece W by the ink discharged from the head 3a on adjacent trajectories do not overlap with each other, the pixel Px corresponding to a dot of ink printed from the head 3a on the workpiece W is defined as a “main dot.” The main dot is determined, for example, by regarding each dot that is printed on the workpiece W from the head 3a on each trajectory as a particle, and performing exclusion processing between dots that are within an influence radius. This search for exclusion processing starts from the central nozzle N having the best conditions among the plurality of nozzles N of the head 3a, and is performed for all dots in all passes. The dot exclusion processing is not limited to the processing using a particle, and may be, for example, processing using a voxel. In addition, the contents (method of setting a plurality of candidate paths) of U.S. Patent Application Publication No. 2024/0269855 published on Aug. 15, 2024 is incorporated herein as a reference for the exclusion processing of the dots.

When printing is performed only with such a main dot, a deterioration in image quality, known as white or black streaks is likely to occur between regions printed on the workpiece W by the ink discharged from the head 3a on adjacent trajectories due to operational errors of the robot 2, errors in the landing of ink from the nozzle N onto the workpiece W, and the like. As a printing method for suppressing such a deterioration in image quality, there is a printing method by partial overlap (POL) processing of overlapping some of the regions printed on the workpiece W by the ink discharged from the head 3a on the adjacent trajectories.

Therefore, in the correspondence information generation step S3, when the first image G1 is printed by POL processing between the first printing trajectory RU-1 or the third printing trajectory RU-3 and the second printing trajectory RU-2 and the fourth printing trajectory RU-4, the pixel Px corresponding to a dot printed in place of a main dot in the region subjected to POL processing is defined as a “sub-dot”.

Furthermore, in the correspondence information generation step S3, when the pass is divided in the main scanning direction DM and the first image G1 is printed by POL processing, such as the first printing trajectory RU-1 and the third printing trajectory RU-3, a dot that is printed in place of a main dot in the region subjected to POL processing in the main scanning direction DM is defined as a “main scanning POL sub-dot”. The main scanning POL sub-dot is, for example, a dot printed on a pass divided by the existing main dot and the sub-dot in the main scanning direction DM, is not a main dot, and is not a sub-dot of another dot.

In the correspondence information generation step S3, in addition to the correspondence relationship between each nozzle N of the head 3a and the pixels Px of the first image G1 in the movement trajectory RU, the distance PG between each nozzle N and the printing region RP, the angle θ formed by the discharge direction of the liquid from each nozzle N and the printing region RP, the distance between the nozzle N and the center of the head 3a, and the distance between the nozzle N and the end of the printing region RP in the main scanning direction DM are obtained, and information related thereto is included in the correspondence information Dc. The details of the correspondence information Dc will be described later with reference to FIG. 8.

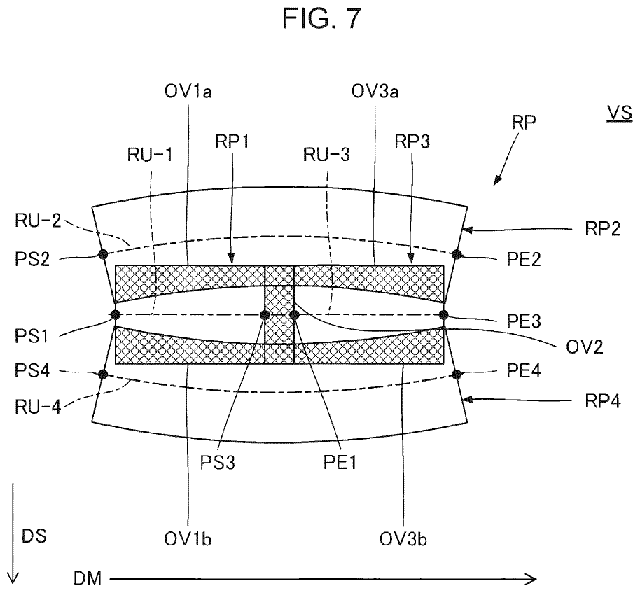

FIG. 7 is an explanatory diagram of the movement trajectory RU and the printing region RP. In FIG. 7, the maximum printing region RP when the printing operation using the first printing trajectory RU-1, the second printing trajectory RU-2, the third printing trajectory RU-3, and the fourth printing trajectory RU-4 is executed is illustrated in a plan view for easy understanding.

When the printing operation of moving the head 3a along the first printing trajectory RU-1 is executed, the ink is applied to a first region RP1 on the workpiece W. That is, the first region RP1 is a region printed with the liquid discharged from the head 3a moving along the first printing trajectory RU-1. When the printing operation of moving the head 3a along the second printing trajectory RU-2 is executed, the ink is applied to a second region RP2 on the workpiece W. That is, the second region RP2 is a region printed with the liquid discharged from the head 3a moving along the second printing trajectory RU-2. When the printing operation of moving the head 3a along the third printing trajectory RU-3 is executed, the ink is applied to a third region RP3 on the workpiece W. That is, the third region RP3 is a region printed with the liquid discharged from the head 3a moving along the third printing trajectory RU-3. When the printing operation of moving the head 3a along the fourth printing trajectory RU-4 is executed, the ink is applied to a fourth region RP4 on the workpiece W. That is, the fourth region RP4 is a region printed with the liquid discharged from the head 3a moving along the fourth printing trajectory RU-4.

Here, the first printing trajectory RU-1 is a trajectory for moving the head 3a from a position PS1 to a position PE1. The second printing trajectory RU-2 is a trajectory for moving the head 3a from a position PS2 to a position PE2, and is adjacent to the first printing trajectory RU-1 in the sub-scanning direction DS. The third printing trajectory RU-3 is a trajectory for moving the head 3a from a position PS3 to a position PE3, and is adjacent to the first printing trajectory RU-1 in the main scanning direction DM. The fourth printing trajectory RU-4 is a trajectory for moving the head 3a from a position PS4 to a position PE4, and is adjacent to the first printing trajectory RU-1 in the sub-scanning direction DS on the opposite side to the second printing trajectory RU-2.

The second region RP2 overlaps with the first region RP1 in the first overlapping region OV1a and overlaps with the third region RP3 in the third overlapping region OV3a. The first overlapping region OV1a is a region in which the first region RP1 and the second region RP2 overlap, and can be printed by sub-dots of the head 3a moving along the first printing trajectory RU-1 and the second printing trajectory RU-2. The third overlapping region OV3a is a region in which the second region RP2 and the third region RP3 overlap, and can be printed by sub-dots of the head 3a moving along the second printing trajectory RU-2 and the third printing trajectory RU-3.

The first region RP1 and the third region RP3 overlap with each other in the second overlapping region OV2. The second overlapping region OV2 is a region in which the first region RP1 and the third region RP3 overlap, and can be printed by the main scanning POL sub-dots of the head 3a moving along the first printing trajectory RU-1 and the third printing trajectory RU-3.

The fourth region RP4 overlaps with the first region RP1 in a fourth overlapping region OV1b and overlaps with the third region RP3 in a fifth overlapping region OV3b. The fourth overlapping region OV1b is a region in which the first region RP1 and the fourth region RP4 overlap, and can be printed by sub-dots of the head 3a moving along the first printing trajectory RU-1 and the fourth printing trajectory RU-4. The fifth overlapping region OV3b is a region in which the third region RP3 and the fourth region RP4 overlap, and can be printed by sub-dots of the head 3a moving along the fourth printing trajectory RU-4 and the third printing trajectory RU-3. In the following description, the first overlapping region OV1a, the second overlapping region OV2, the third overlapping region OV3a, the fourth overlapping region OV1b, and the fifth overlapping region OV3b may be referred to as an overlapping region OV without distinction.

In the first printing data generation step S5, the printing data Img1 is generated based on the correspondence information Dc and the first image information Dg1.

Specifically, in the first printing data generation step S5, first, sub-dots for which the difference between the distance PG corresponding to the main dot and the distance PG corresponding to each sub-dot is outside an allowable range designated by the user are excluded. This restricts the width of each overlapping region OV, such as the first overlapping region OV1a described above to restrict the use of dots that are likely to cause a deterioration in printing quality. The allowable range is acquired as a setting value in the above-described first image information acquisition step S1. Therefore, the width of each overlapping region OV is adjusted based on the setting value.

In addition, in the first printing data generation step S5, when POL processing is performed, it is determined for each nozzle N whether to print a sub-dot or a main dot, in accordance with the following conditions.

First, for each dot, the occurrence ratio of a POL in the sub-scanning direction DS and the occurrence ratio of a POL in the main scanning direction DM are calculated. The occurrence ratio of the POL is used to specify a sub-dot. For example, the occurrence ratio of the POL is shown in percentage.

The occurrence ratio of the POL in the sub-scanning direction DS is calculated based on the distance between the nozzle N and the center of the nozzle surface FN, and increases as the distance increases. Specifically, the occurrence ratio of the POL in dots discharged from the nozzle N located at the center of the nozzle surface FN is set to 0%, and the occurrence ratio of the POL in dots discharged from the nozzle N located at the end portion of the nozzle surface FN in the sub-scanning direction DS is set to 100%.

The occurrence ratio of the POL in the main scanning direction DM increases toward the end portions in the main scanning direction DM. Specifically, the occurrence ratio of the POL in the main scanning direction DM is set in a region up to a specific length, for example 5 mm, from the end portion of the first region RP1 toward the center in the main scanning direction DM, and is set so that the occurrence ratio of the POL in dots at one end portion side of the end portion of the first region RP1 in that region is 100%, and the occurrence ratio of POL in dots at the other end side of that region is 0%.

A table is created that takes into account the occurrence ratio of these POLs in each dot. Then, based on the comparison result between the value of the table and the mask value of a POL mask, the dot corresponding to the value exceeding the mask value is determined as a sub-dot instead of a main dot. In the following, the POL in the sub-scanning direction DS may be referred to as a sub-scanning POL. Similarly, the POL in the main scanning direction DM may be referred to as a main scanning POL.

From the above results, information on which dots are determined to be printed is compiled for each pass, and the printing data Img1 is created. As a result, in the overlapping region OV, the occurrence ratio of the dots can be reduced, thereby achieving a smooth change in tone.

FIG. 8 is a diagram illustrating an example of the correspondence information Dc. FIG. 8 illustrates an example of the correspondence information Dc when the POL processing is performed in each of the main scanning direction DM and the sub-scanning direction DS.

As illustrated in FIG. 8, the correspondence information Dc includes pixel information Dc1a, distance information Dc2a, angle information Dc3a, occurrence ratio information Dc4a, first overlapping pixel information Dc1b, first distance information Dc2b, first angle information Dc3b, first occurrence ratio information Dc4b, second overlapping pixel information Dc1c, second distance information Dc2c, second angle information Dc3c, and second occurrence ratio information Dc4c.

Here, the pixel information Dc1a, the distance information Dc2a, the angle information Dc3a, and the occurrence ratio information Dc4a are information related to main dots. The first overlapping pixel information Dc1b, the first distance information Dc2b, the first angle information Dc3b, and the first occurrence ratio information Dc4b are information related to the sub-dots in the overlapping region OV in the sub-scanning direction DS. The second overlapping pixel information Dc1c, the second distance information Dc2c, the second angle information Dc3c, and the second occurrence ratio information Dc4c are information related to the sub-dots in the overlapping region OV in the main scanning direction DM, that is, information related to the main scanning POL sub-dots. In addition, one or both of the information related to the sub-dots of the overlapping region OV in the sub-scanning direction DS and the information related to the sub-dots of the overlapping region OV in the main scanning direction DM may be included in the correspondence information Dc as necessary, or may be omitted.

The pixel information Dc1a is information indicating a correspondence relationship between the nozzles N of the head 3a and the pixels Px in the printing region RP of the workpiece W in the movement trajectory RU. The pixel information Dc1a is information indicating a correspondence relationship between the nozzles N of the head 3a and the pixels Px in the printing region RP of the workpiece W in the movement trajectory RU. In the example illustrated in FIG. 8, the pixel information Dc1a includes information indicating the “pass number of dots to be printed”, the “nozzle number of dots to be printed”, the “shot number of dots to be printed”, the “image reference position (x coordinate)”, and the “image reference position (y coordinate)”. The image reference position (x coordinate) is a normalized x coordinate value of the pixel Px of the first image G1 in the two-dimensional xy coordinate system. The image reference position (y coordinate) is a normalized y coordinate value of the pixel Px of the first image G1 in the two-dimensional xy coordinate system.

The distance information Dc2a is information related to the distance PG between the nozzle N of the head 3a and the printing region RP in the movement trajectory RU. Here, the distance information Dc2a is associated with a set of a “pass number of dots to be printed”, a “nozzle number of dots to be printed”, and a “shot number of dots to be printed”.

The angle information Dc3a is information related to the angle θ formed by a liquid discharge direction from the nozzle N of the head 3a and the printing region RP. Here, the angle information Dc3a is associated with a set of “the pass number of dots to be printed”, “the nozzle number of dots to be printed”, and “the shot number of dots to be printed”.

The occurrence ratio information Dc4a is information related to the occurrence ratio of the above-described dots for main dots. In the example illustrated in FIG. 8, the occurrence ratio information Dc4a includes information indicating the “occurrence ratio of the main scanning POL” and the “occurrence ratio of the sub-scanning POL”.

The first overlapping pixel information Dc1b is information indicating the correspondence relationship between the pixels Px of the overlapping region OV in each of the first overlapping region OV1a, the third overlapping region OV3a, the fourth overlapping region OV1b, and the fifth overlapping region OV3b and the nozzles N of the head 3a. In the example illustrated in FIG. 8, the first overlapping pixel information Dc1b includes information indicating the “pass number of dots to be printed”, the “nozzle number of dots to be printed”, the “shot number of dots to be printed”, the “image reference position (x coordinate)”, and the “image reference position (y coordinate)”, similar to the pixel information Dc1a.

The first distance information Dc2b is information related to the distance PG between the nozzles N of the head 3a and the overlapping region OV in each of the first overlapping region OV1a, the third overlapping region OV3a, the fourth overlapping region OV1b, and the fifth overlapping region OV3b. Here, the first distance information Dc2b is associated with a set of the “pass number for dots to be printed”, the “nozzle number for dots to be printed”, and the “shot number for dots to be printed”.

The first angle information Dc3b is information related to the angle θ formed by the discharge direction DE of the liquid from the nozzles N of the head 3a and the overlapping region OV in each of the first overlapping region OV1a, the third overlapping region OV3a, the fourth overlapping region OV1b, and the fifth overlapping region OV3b. Here, the first angle information Dc3b is associated with a set of “the pass number of dots to be printed”, “the nozzle number of dots to be printed”, and “the shot number of dots to be printed”.

The first occurrence ratio information Dc4b is information related to the occurrence ratio of the above-described dots for sub-dots. In the example illustrated in FIG. 8, the first occurrence ratio information Dc4b includes information indicating the “occurrence ratio of the main scanning POL” and the “occurrence ratio of the sub-scanning POL”.

The second overlapping pixel information Dc1c is information indicating a correspondence relationship between the pixels of the second overlapping region OV2 and the nozzles N of the head 3a. In the example illustrated in FIG. 8, the second overlapping pixel information Dc1c includes information indicating the “pass number of dots to be printed”, the “nozzle number of dots to be printed”, the “shot number of dots to be printed”, the “image reference position (x coordinate)”, and the “image reference position (y coordinate)”, similar to the pixel information Dc1a.

The second distance information Dc2c is information related to the distance PG between the nozzles N of the head 3a and the second overlapping region OV2. Here, the second distance information Dc2c is associated with a set of the “pass number of dots to be printed”, the “nozzle number of dots to be printed”, and the “shot number of dots to be printed”.

The second angle information Dc3c is information related to the angle θ formed by the discharge direction DE of the liquid from the nozzles N of the head 3a and the second overlapping region OV2. Here, the second angle information Dc3c is associated with a set of the “pass number of dots to be printed”, “nozzle number of dots to be printed”, and “shot number of dots to be printed”.

The second occurrence ratio information Dc4c is information related to the occurrence ratio of the above-described dots for the main scanning POL sub-dots. In the example illustrated in FIG. 8, the second occurrence ratio information Dc4c includes information indicating the “occurrence ratio of the main scanning POLs” and the “occurrence ratio of the sub-scanning POLs”.

The above-described correspondence information Dc is stored in the storage circuit 7a in the storage step S4. By using the correspondence relationship indicated by the correspondence information Dc, the printing data Img can be generated even if the image to be printed is changed. Therefore, in the second printing data generation step S14, the printing data Img2 for printing the second image G2 indicated by the second image information Dg2 is generated without generating the trajectory information Da again by using the correspondence relationship indicated by the correspondence information Dc. As a result, the time required for generating the printing data Img2 can be shortened as compared with the aspect of generating the trajectory information Da again.

In addition, when multi-color printing is performed, the printing data for each color for multi-color printing can be generated by applying the halftone data for each color such as CMYK to the correspondence relationship indicated by the correspondence information Dc.

Furthermore, when the POL processing is performed, the dot pattern in the overlapping region OV can be changed by changing the POL mask. When multi-color printing is performed, it is possible to generate the printing data Img2 in which the printing unevenness is reduced by making the POL masks used for creating the printing data of each color different from each other.

In addition, since the correspondence information Dc includes the information related to the distance PG and the angle θ, it is also possible to suppress the deterioration of the image quality by adjusting the size (width) of the overlapping region OV according to the type of the image.

### 1-7. Printing Data of First Image and First Printing Step

FIG. 9 is an explanatory diagram of the printing data Img1 for printing the first image G1. FIG. 10 is an explanatory diagram of another example of the printing data Img1 for printing the first image G1. In FIGS. 9 and 10, the first region RP1 and the third region RP3 of the first image G1 are illustrated. In FIGS. 9 and 10, for convenience of description, the first region RP1 and the third region RP3 of the first image G1 are illustrated with spacing therebetween.

In the first printing step S6, the first image G1 is printed based on the printing data Img1. Here, when the first image G1 is printed without performing the POL processing, as illustrated in FIG. 9, an image G1a corresponding to the first region RP1 of the first image G1 and an image G1b corresponding to the third region RP3 are printed. The images G1a and G1b are images composed only of main dots. That is, the images G1a and G1b are images that do not have the overlapping region OV.

In addition, when the POL processing is performed to print the first image G1, as illustrated in FIG. 10, the image G1c corresponding to the first region RP1 of the first image G1 and the image G1d corresponding to the third region RP3 are printed. The images G1c and G1d are images composed of main dots, sub-dots, and main scanning POL sub-dots. That is, the images G1c and G1d are images having the overlapping region OV.

### 1-8. Printing Data of Second Image and Second Printing Step

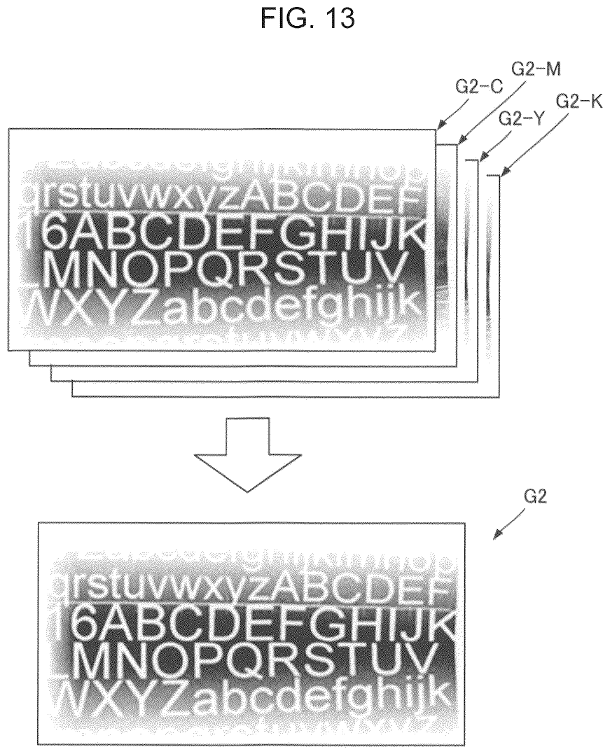

FIG. 11 is an explanatory diagram of the printing data Img2 for printing the second image G2. FIG. 12 is an explanatory diagram of another example of the printing data Img2 for printing the second image G2. FIG. 13 is an explanatory diagram of the printing data Img2 for multi-color printing. FIGS. 11 and 12 illustrate the first region RP1 and the third region RP3 of the second image G2. In FIG. 13, the third region RP3 of the second image G2 is illustrated. In FIGS. 11 and 12, for convenience of description, the first region RP1 and the third region RP3 of the second image G2 are illustrated with spacing therebetween.

In the second printing data generation step S14, the printing data Img2 is generated based on the correspondence information Dc and the second image information Dg2. As described above, since the correspondence information Dc generated as intermediate data when the printing data Img1 of the first image G1 is generated is used for generating the printing data Img2 of the second image G2, it is not necessary to create the movement trajectory RU for each image, and as a result, the time required to create the movement trajectory RU can be reduced.

Here, by using the pixel information Dc1a, the correspondence information Dc can be used to generate the printing data Img2 of the second image G2. In addition, by using the distance information Dc2a, even if the variation in the distance PG between each nozzle N of the head 3a and the workpiece W becomes large depending on the shape of the workpiece W, the printing quality can be improved by adjusting the nozzle N used for discharge based on the distance information Dc2a.

In the second printing step S15, the second image G2 is printed based on the printing data Img2. Here, when the second image G2 is printed without performing the POL processing, as illustrated in FIG. 11, an image G2a corresponding to the first region RP1 of the second image G2 and an image G2b corresponding to the third region RP3 are printed. The images G2a and G2b are images composed only of main dots. That is, the images G2a and G2b are images that do not have the overlapping region OV.

As described above, in the second printing step S15, the second image G2 different from the first image G1 is printed. Here, in both the first printing step S6 and the second printing step S15, the robot 2 moves the head 3a along the movement trajectory RU. As described above, even if the printing is performed on the new workpiece W, when the shape of the workpiece W is not changed, since the movement trajectory RU of the head 3a is shared between the printing of the first image G1 and the printing of the second image G2, it is not necessary to create the movement trajectory RU for each image, and as a result, the time required to create the movement trajectory RU can be reduced.

In addition, when the POL processing is performed to print the second image G2, as illustrated in FIG. 12, the image G2c corresponding to the first region RP1 of the second image G2 and the image G2d corresponding to the third region RP3 are printed. The images G2c and G2d are images composed of main dots, sub-dots, and main scanning POL sub-dots. That is, the images G2c and G2d are images having the overlapping region OV.

Here, in the second printing data generation step S14, based on the information such as the correspondence relationship indicated by the first overlapping pixel information Dc1b and the setting value indicated by the instruction information Dd, the width of the overlapping region OV in each of the first overlapping region OV1a, the third overlapping region OV3a, the fourth overlapping region OV1b, and the fifth overlapping region OV3b, or the amount of liquid discharged to the overlapping region OV can be changed according to the type of the image to be printed or the instruction by the user. As a result, the printing quality of the overlapping region OV can be improved or to the printing quality of the overlapping region OV is adjusted according to the user's request. For example, when the setting value information includes information related to the type of the image, such as a line drawing or a photograph, adjustments are made such that the width of the overlapping region OV is narrowed in the case of a line drawing, and widened in the case of a photograph.

In addition, by using the first distance information Dc2b, even if the variation in the distance PG between each nozzle N of the head 3a and the workpiece W becomes large depending on the shape of the workpiece W, the printing quality can be improved by adjusting the nozzle N used for discharge based on the first distance information Dc2b and information such as the setting value indicated by the instruction information Dd.

Furthermore, based on the information such as the correspondence relationship indicated by the second overlapping pixel information Dc1c and the setting value indicated by the instruction information Dd, the width of the second overlapping region OV2 or the amount of the liquid discharged into the second overlapping region OV2 can be changed depending on the type of image to be printed or the instruction by the user. As a result, the printing quality of the second overlapping region OV2 can be improved or the printing quality of the second overlapping region OV2 can be adjusted according to the user's request.

In the present embodiment, in the overlapping region adjustment step S13, the size of each of the first overlapping region OV1a, the third overlapping region OV3a, the fourth overlapping region OV1b, and the fifth overlapping region OV3b is adjusted. As a result, the printing quality of these overlapping regions OV can be adjusted according to the user's preference by adjusting the size of the overlapping region OV for each image.

In the overlapping region adjustment step S13, the size of each of the first overlapping region OV1a, the third overlapping region OV3a, the fourth overlapping region OV1b, and the fifth overlapping region OV3b is adjusted based on the first distance information Dc2b. As a result, printing quality in these overlapping regions OV can be improved by reducing the use of the nozzle N having a large distance PG for these overlapping regions OV.

Furthermore, in the overlapping region adjustment step S13, the size of each of the first overlapping region OV1a, the third overlapping region OV3a, the fourth overlapping region OV1b, and the fifth overlapping region OV3b is adjusted based on the first angle information Dc3b. As a result, the printing quality of these overlapping regions OV can be improved by reducing the use of the nozzle N having the angle θ formed by the discharge direction DE and the overlapping regions OV larger than 90°. More specifically, for each nozzle N, the printing quality of the overlapping region OV can be improved by determining whether the angle θ exceeds a threshold value, restricting the use of nozzles N whose angle θ exceeds the threshold value is restricted, and narrowing the width of the overlapping region OV so that the overlapping regions OV are printed with dots from nozzles N whose angle θ is equal to or less than the threshold value.

In the overlapping region adjustment step S13, the size of each of the first overlapping region OV1a, the third overlapping region OV3a, the fourth overlapping region OV1b, and the fifth overlapping region OV3b is adjusted based on the instruction information Dd. As a result, the printing quality of these overlapping regions OV can be adjusted according to the user's preference.

Furthermore, when the second image G2 is printed by multi-color printing, as illustrated in FIG. 13, images G2-C, G2-M, G2-Y, and G2-K based on the printing data Img2 of each color are printed in sequence, and thus the multi-colored second image G2 is printed. In the example illustrated in FIG. 13, the image G2-C is a cyan image, the image G2-M is a magenta image, the image G2-Y is a yellow image, and the image G2-K is a black image. The printing data Img2 of the images G2-C, G2-M, G2-Y, and G2-K are generated by using different POL masks so that the dots do not overlap with each other. The colors and the number of colors of the multi-color printing are not limited to cyan, magenta, yellow, and black, and are optional.

As described above, in the second printing data generation step S14, the printing data Img2 is generated for each liquid color based on the correspondence information Dc. As a result, when color printing is performed, the time required for generating the printing data Img2 for all colors can be shortened as compared with the aspect in which the printing data is created for each color based on the trajectory information Da and the second image information Dg2 for each color.

Here, as described above, in the second printing data generation step S14, the printing data Img2 is generated by changing the mask pattern for each liquid color. That is, the control method includes a step of changing the mask pattern for each liquid color in each of the first overlapping region OV1a, the third overlapping region OV3a, the fourth overlapping region OV1b, and the fifth overlapping region OV3b to generate the printing data Img2. As a result, the overlapping of the dots of different colors in these overlapping regions OV can be reduced. As a result, the unevenness in these overlapping regions OV can be reduced.

However, the same mask pattern is used for printing the images of the same color between the passes. For example, the mask pattern used for the first region RP1 and the mask pattern used for the second region RP2 are the same as each other. As a result, the unevenness in the overlapping region OV can be reduced.

### 2. Modification Example

The embodiments in the above examples can be variously modified. Specific modification aspects applicable to each of the above-described embodiments are illustrated below. It should be noted that two or more aspects randomly selected from the following examples can be appropriately merged without contradicting each other.

### 2-1. Modification Example 1

In the above-described embodiment, an aspect in which the first image information acquisition step S1 to the determination step S16 are executed as a series of steps is exemplified, but the present disclosure is not limited to this aspect, and for example, the correspondence information Dc may be stored in the storage circuit 7a in advance. In this case, when the same movement trajectory RU as the movement trajectory RU when the correspondence information Dc is created is used, the printing data Img is generated by using the correspondence information Dc. In this case, for example, the determination step S16 is performed from the second image information acquisition step S10 illustrated in FIG. 2.

In addition, the correspondence information Dc may be generated for each workpiece having a different shape and stored in the storage circuit 7a. For example, when the workpiece is changed to a workpiece having a different shape, the correspondence information Dc of the workpiece may be acquired from the storage circuit 7a, and the printing data may be generated by using the correspondence information Dc.

In addition, the correspondence information Dc may be acquired from a circuit other than the storage circuit 7a. For example, the correspondence information Dc may be acquired from an external server connected to the control portion 8.

### 2-2. Modification Example 2

In the above-described embodiment, an aspect in which a 6-axis vertical multi-axis robot is used as the movement mechanism that moves the head 3a is described as an example, but the present disclosure is not limited to this aspect, and the movement mechanism may be, for example, a vertical multi-axis robot other than the 6-axis robot, a horizontal multi-axis robot, or a mechanism in which a linear motion mechanism that moves the head 3a along the X-axis and a linear motion mechanism that moves the head 3a along the Z-axis are combined. Further, the arm portion of the robot may have a telescopic mechanism, a linear motion mechanism, or the like in addition to the joint configured with the rotation mechanism.

### 2-3. Modification Example 3

In the embodiment described above, the configuration using screwing or the like as a method of fixing the head 3a to the robot 2 is described, and the configuration is not limited to this configuration. For example, the head 3a may be fixed to the robot 2 by gripping the head 3a with a gripping mechanism such as a hand mounted as an end effector of the robot 2.

### 2-4. Modification Example 4

The use of the three-dimensional object printing apparatus of the present disclosure is not limited to image printing. For example, a three-dimensional object printing apparatus that discharges a solution of a coloring material is used as a manufacturing apparatus that forms a color filter of a liquid crystal display apparatus. A three-dimensional object printing apparatus that discharges a solution of a conductive material is used as a manufacturing apparatus for forming a wiring and an electrode on a wiring substrate. In addition, the three-dimensional object printing apparatus can also be used as a jet dispenser of applying a liquid such as an adhesive to a medium.

What is claimed is:

1. A control method for controlling an operation of a three-dimensional object printing apparatus including a liquid discharge head that discharges liquid toward a workpiece, and a movement mechanism that moves the liquid discharge head, the control method comprising:
a trajectory information generation step of generating trajectory information related to a movement trajectory along which the movement mechanism moves the liquid discharge head;
a correspondence information generation step of generating correspondence information in which the trajectory information, head information related to the liquid discharge head, and first image information related to a first image to be printed are associated;
a storage step of storing the correspondence information; and
a printing data generation step of generating printing data for printing a second image to be printed based on the correspondence information and second image information related to the second image to be printed.

2. The control method according to claim 1, wherein
the correspondence information includes pixel information indicating a correspondence relationship between nozzles of the liquid discharge head and pixels of a printing region of the workpiece in the movement trajectory.

3. The control method according to claim 2, wherein
the correspondence information includes distance information related to a distance between the nozzles of the liquid discharge head and the printing region in the movement trajectory.

4. The control method according to claim 3, wherein
the movement trajectory includes
a first printing trajectory, and
a second printing trajectory adjacent to the first printing trajectory in a sub-scanning direction intersecting a main scanning direction along the first printing trajectory, and
the correspondence information includes first overlapping pixel information indicating a correspondence relationship between pixels of a first overlapping region in which a first region printed by liquid discharged from the liquid discharge head moving along the first printing trajectory and a second region printed by liquid discharged from the liquid discharge head moving along the second printing trajectory overlap, and the nozzles of the liquid discharge head.

5. The control method according to claim 4, wherein
the movement trajectory further includes a third printing trajectory adjacent to the first printing trajectory in the main scanning direction along the first printing trajectory, and
the correspondence information includes second overlapping pixel information indicating a correspondence relationship between pixels of a second overlapping region in which a third region printed by liquid discharged from the liquid discharge head moving along the third printing trajectory and the first region overlap, and the nozzles of the liquid discharge head.

6. The control method according to claim 4, further comprising:
an overlapping region adjustment step of adjusting a size of the first overlapping region.

7. The control method according to claim 6, wherein
the correspondence information includes first distance information related to a distance between the nozzles of the liquid discharge head and the first overlapping region, and
in the overlapping region adjustment step, the size of the first overlapping region is adjusted based on the first distance information.

8. The control method according to claim 6, wherein
the correspondence information further includes first angle information related to an angle formed by a discharge direction of the liquid from the nozzles of the liquid discharge head and the first overlapping region, and
in the overlapping region adjustment step, the size of the first overlapping region is adjusted based on the first angle information.

9. The control method according to claim 6, further comprising:
an instruction acquisition step of acquiring instruction information related to a user's instruction, wherein in the overlapping region adjustment step, the size of the first overlapping region is adjusted based on the instruction information.

10. The control method according to claim 4, further comprising:
generating printing data by changing a mask pattern for each liquid color in the first overlapping region.

11. The control method according to claim 1, wherein
in the printing data generation step, printing data is generated for each liquid color based on the correspondence information.

12. The control method according to claim 11, wherein
in the printing data generation step, printing data is generated by changing a mask pattern for each liquid color.

13. The control method according to claim 12, wherein
the movement trajectory includes
a first printing trajectory, and
a second printing trajectory adjacent to the first printing trajectory in a sub-scanning direction intersecting a main scanning direction along the first printing trajectory,
the correspondence information includes first overlapping pixel information indicating a correspondence relationship between pixels of a first overlapping region in which a first region printed by liquid discharged from the liquid discharge head moving along the first printing trajectory and a second region printed by liquid discharged from the liquid discharge head moving along the second printing trajectory overlap, and the nozzles of the liquid discharge head, and
a mask pattern used for the first region and a mask pattern used for the second region are the same.

14. A control method for controlling an operation of a three-dimensional object printing apparatus including a liquid discharge head that discharges liquid toward a workpiece, and a movement mechanism that moves the liquid discharge head, the control method comprising:
a trajectory information generation step of generating trajectory information related to a movement trajectory along which the movement mechanism moves the liquid discharge head;
a first printing step of printing a first image; and
a second printing step of printing a second image different from the first image, wherein
in both the first printing step and the second printing step, the movement mechanism moves the liquid discharge head along the movement trajectory.
